(19) United States
(12) Patent Application Publication
(10) Pub. No.: US 2005/0134110 A1
(43) Pub. Date: Jun. 23, 2005

(54) Brake assembly with brake response system

(76) Inventors: David F. Reuter, Dayton, OH (US); Daniel N. Borgenmenke, Springboro, OH (US); E. Wayne Lloyd, Lebanon, OH (US); Matthew A. Cukovecki, New Carlisle, OH (US); James R. Bond, Centerville, OH (US)

Correspondence Address: Delphi Technologies, Inc.;Legal Staff - Intellectual Property, M/C 480-410-202, P. O. Box 5052, Troy, MI, 48007-5052, US

(21) Appl. No.: 10/899,661

(22) Filed: Jul. 27, 2004

Related U.S. Application Data
(63) Continuation-in-part of application No. 10/742,537, filed on Dec. 19, 2003.

(51) Int. Cl. B60T 13/00

(52) U.S. Cl. 303/114.1

(57) ABSTRACT

A braking system including a master cylinder, a brake subsystem for applying pressure to a brake rotor, and an apply conduit configured to selectively to allow the flow of fluid therethrough. The apply conduit selectively allows fluid to flow from the master cylinder to the brake subsystem to thereby cause the brake subsystem to apply or increase pressure to the brake rotor. The braking system further includes a bypass conduit configured to selectively allow the flow of fluid therethrough from the master cylinder to the brake subsystem to thereby cause the brake subsystem to apply pressure to the brake rotor.

This application is a continuation-in-part of U.S. application Ser. No. 10/742,537, filed Dec. 19, 2003, the contents of which are hereby incorporated by reference.

The present invention is directed to a brake assembly, and more particularly, to a brake assembly having a brake response system which allows additional flow of brake fluid to a brake caliper.

### BACKGROUND

In most existing analog brake systems, when the driver presses on the brake pedal brake fluid is forced under pressure from a master cylinder to the caliper to cause the caliper/brake pad of a wheel brake system to move against the rotor of the wheel. The frictional engagement between the rotor and the brake pad brakes the system and causes the associated wheel to decelerate in a well-known manner.

In antilock brake systems (“ABS”), the brake system or assembly includes an apply valve to control the flow of fluid therethrough during application of the brakes in an ABS event. The apply valve has an opening or orifice through which the fluid flows. The orifice has a defined or fixed size which is relatively small to allow controlled adjustments of the pressure in the associated caliper during an ABS or other controlled braking event. However, the limited orifice size of the apply valve may reduce the responsiveness of the brake system due to the limited flow volume which can flow through the restricted orifice. Accordingly, there is a need for an ABS brake system which includes a relatively large orifice to allow high volume flow, while still providing good control during an ABS or controlled braking event.

When using a brake system with a traction control system (“TCS”) or electronic stability control (“ESC”), it is often desired to route the brake fluid from the master cylinder and/or master cylinder reservoir to the inlet of the pump to allow pressurization and application of the brakes through operation of the pump. However, existing master cylinder prime valves and brake lines (which allow fluid to flow from the master cylinder to the inlet of the pump) may have limited size and flow capabilities (i.e., a limited cross sectional area).

In some situations, particularly on larger vehicles, it may be desired to provide a high volume of brake fluid to the inlet of the pump to achieve good brake pressure response times for either TCS or ESC systems. In particular, in cold weather conditions, the viscosity of the brake fluid may be relatively high, in which case it may prove especially useful to incorporate a relatively high volume flow of brake fluid into the system. Accordingly, there is a need for such a high volume flow system that can deliver fluid from the master cylinder and/or master cylinder reservoir to the pump inlet.

When utilizing a TCS, ESC, and/or ABS system, it may be desired to generate relatively high pressures by the pump or pump assembly in order to ensure proper operation of the TCS, ESC, and/or ABS system. It is also desired to provide for a stable pump arrangement which provides a uniform inlet vacuum and outlet pressure source. Accordingly, there is a need for a brake system having a pump arrangement which can generate relatively high pressures and operate in an efficient manner.

### SUMMARY

In one embodiment the present invention is a brake system including a brake response valve and a brake response conduit in fluid communication with a caliper to allow the flow of fluid from the master cylinder to the caliper, while bypassing the apply valve of the ABS brake system. In particular, in one embodiment the invention is a braking system including a master cylinder, a brake subsystem for applying pressure to a brake rotor, and an apply conduit. The apply conduit is configured to selectively allow the flow of fluid therethrough from the master cylinder to the brake subsystem to thereby cause the brake subsystem to apply or increase pressure to the brake rotor. The braking system further includes a bypass conduit configured to selectively allow the flow of fluid therethrough from the master cylinder to the brake subsystem to thereby cause the brake subsystem to apply pressure to the brake rotor.

In another embodiment, the present invention is a brake system configured to deliver fluid from the master cylinder to an inlet of the pump. In particular, in one embodiment the present invention is a brake system which includes a reservoir prime valve and reservoir conduit in fluid communication with the inlet of the pump and the master cylinder and/or master cylinder reservoir. The reservoir prime valve and reservoir conduit allow brake fluid to flow directly from the master cylinder and/or master cylinder reservoir to the pump to allow improved operation during TCS and ESC pressure build cycles.

In particular, in one embodiment the invention is a braking system including a master cylinder having a reservoir, a brake subsystem for applying pressure to a brake rotor, and an apply conduit. The apply conduit is configured to selectively to allow the flow of fluid therethrough from the master cylinder to the brake subsystem to thereby cause the brake subsystem to apply or increase pressure to the brake rotor. The system includes a release conduit configured to selectively to allow the flow of fluid therethrough and away from the brake subsystem to thereby cause the brake subsystem to reduce any pressure to the brake rotor. The system further includes a pump having a pump inlet and a pump outlet, wherein the release conduit is in fluid communication with the pump inlet. The system includes a reservoir conduit configured to selectively allow the flow of fluid therethrough from the master cylinder to the pump inlet.

In another embodiment, the present invention is a brake system including various pump configurations for improved pumping operations. In particular, in one embodiment the invention is a braking system for a vehicle including a master cylinder, a fluid line assembly in fluid communication with master cylinder and at least one brake disposed at a wheel of the vehicle, and a pumping unit in fluid communication with the fluid line assembly. The pumping unit includes toro fluid pumping elements that are arranged to be about 180 degrees out of phase with each other during operation.

Other objects and advantages of the present invention will be apparent from the following description and the accompanying drawings.

### BRIEF DESCRIPTION OF THE DRAWINGS

FIG. 1 is a schematic representation of a baseline ABS brake system with a front/rear split;

FIG. 1A is a schematic representation of the valve layout of the system of FIG. 1;

FIG. 1B is a simplified schematic representation of the front brake circuit of the system of FIG. 1;

FIG. 2 is a schematic representation of the brake system of claim 1, modified to include a brake response valve;

FIG. 2a is a schematic representation of the valve layout of the system of FIG. 2;

FIG. 2b is a simplified schematic representation of the front brake circuit of FIG. 2;

FIG. 3 is a schematic representation of the brake system of FIG. 1, modified to include two brake response valves;

FIG. 4 is a schematic representation of a baseline 4-channel ESC brake system with a front/rear split;

FIG. 4a is a schematic representation of the valve layout of the system of FIG. 4;

FIG. 5 is a schematic representation of the brake system of claim 4, modified to include a brake response valve;

FIG. 5a is a schematic representation of the valve layout of the system of FIG. 5;

FIG. 6 is a schematic representation of a hybrid braking system with the addition of a brake response valve and reservoir prime valve;

FIG. 7 is a schematic representation of a brake system with an ESC system having a brake response valve, reservoir prime valve and two 180° pump elements;

FIG. 7a is a simplified schematic representation of the system of FIG. 7;

FIG. 7b is a schematic representation of the pumping arrangement of the system of FIG. 7;

FIG. 8 is a schematic representation of the brake system of FIG. 7, utilizing two 90° pump elements;

FIG. 8a is a simplified schematic representation of the system of FIG. 8;

FIG. 9 is a schematic representation of the brake system of FIG. 7, with a “3+1” pump configuration;

FIG. 9a is a simplified schematic representation of the system of FIG. 9;

FIG. 10 is a schematic representation of the brake system of FIG. 3 utilizing two 180° pump elements;

FIG. 11 is a schematic illustration of a braking system according to one embodiment of the invention;

FIG. 12 is a graph showing fluid pressure over the operating cycles of pumps according to one embodiment of the invention; and

FIG. 13 is a schematic illustration of a braking system according to another embodiment of the invention.

### DETAILED DESCRIPTION

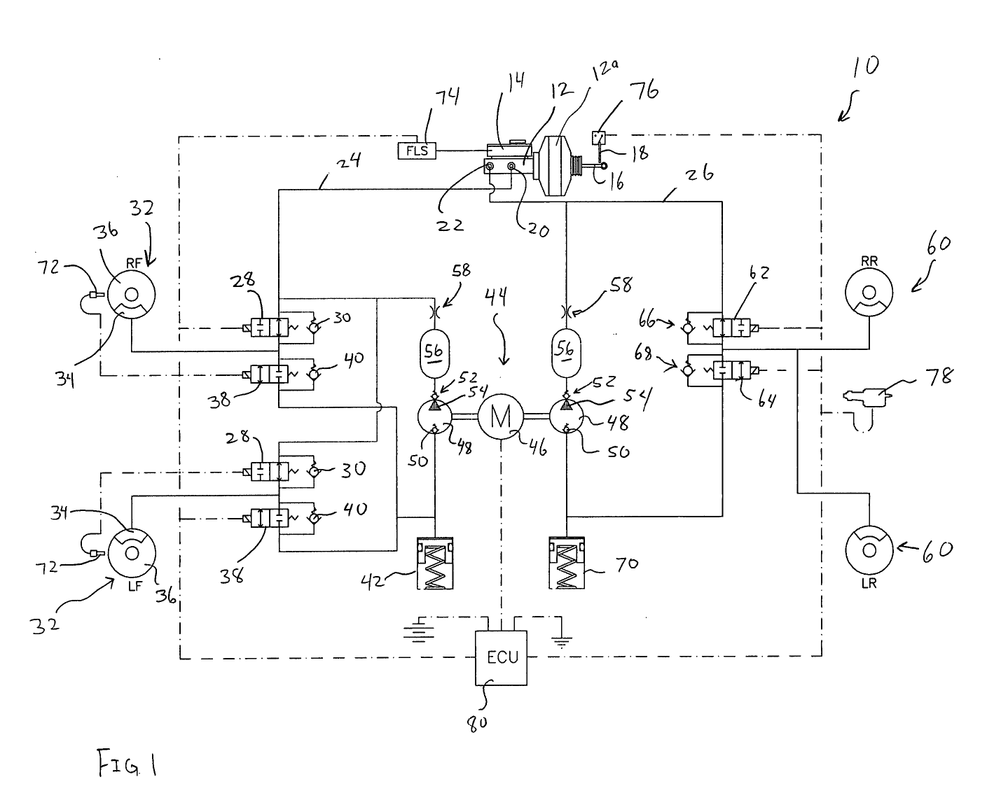

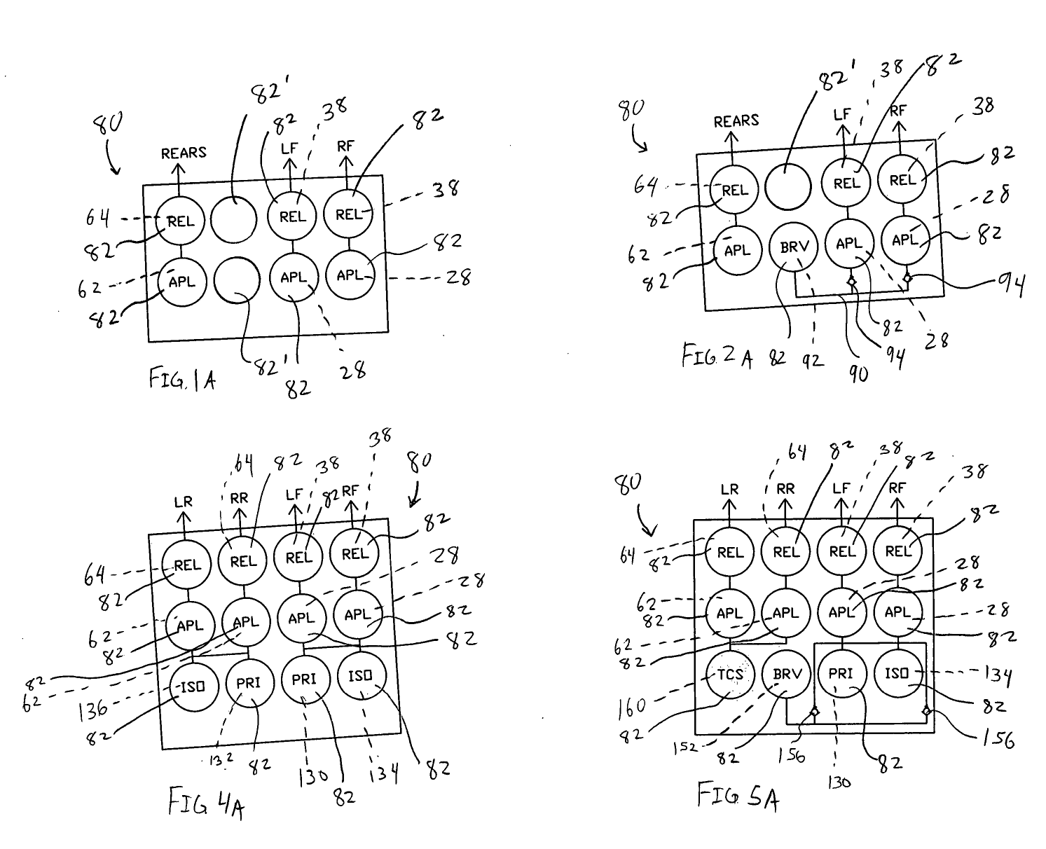

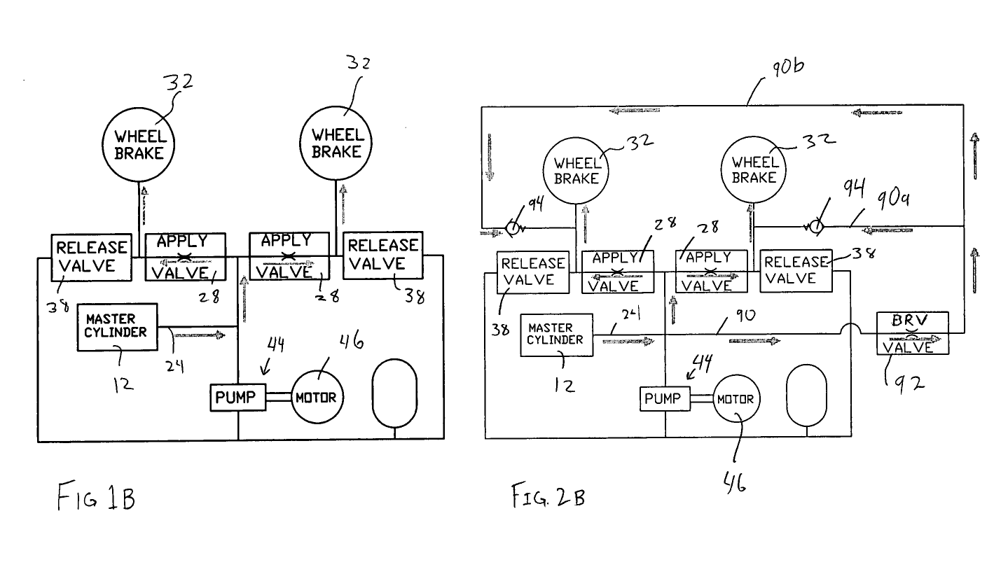

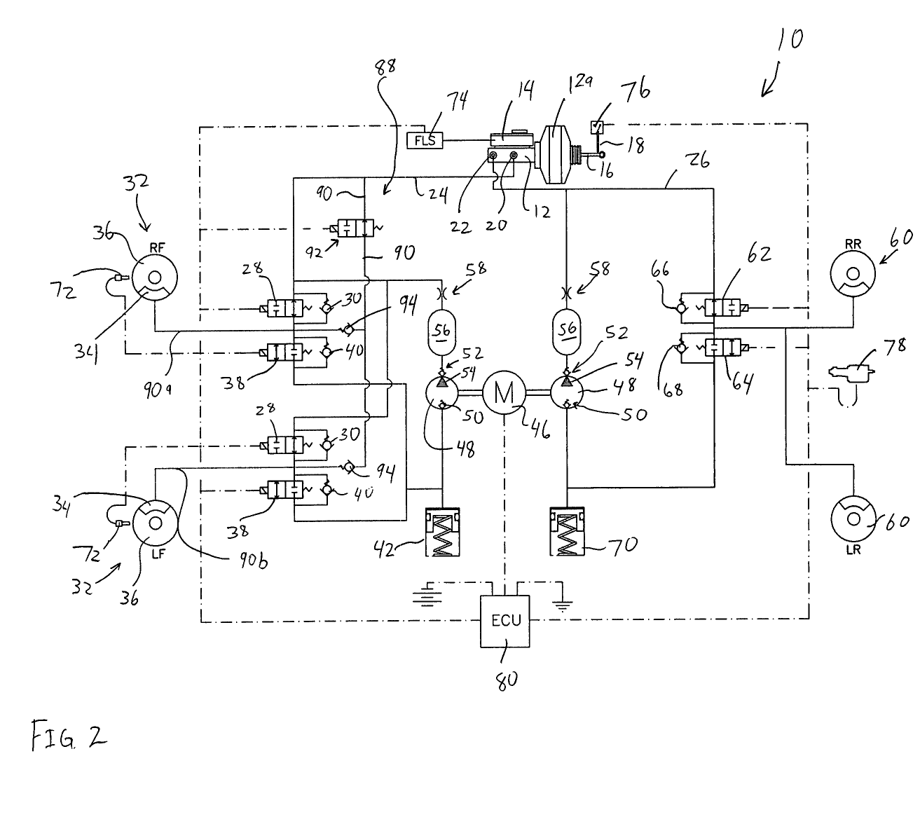

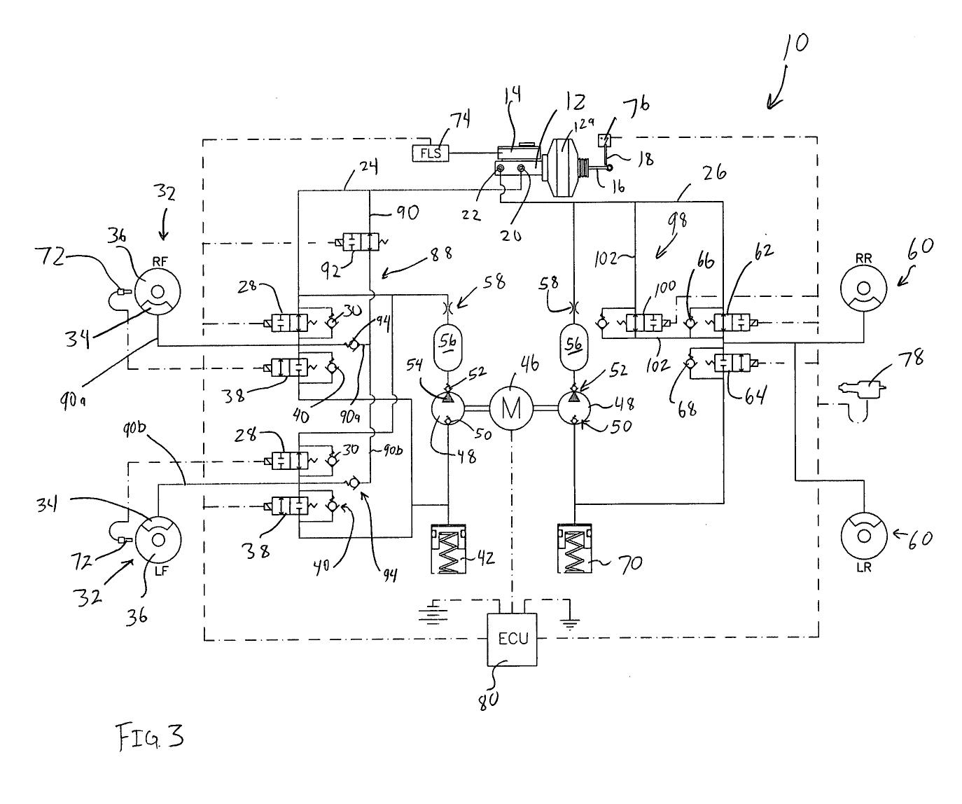

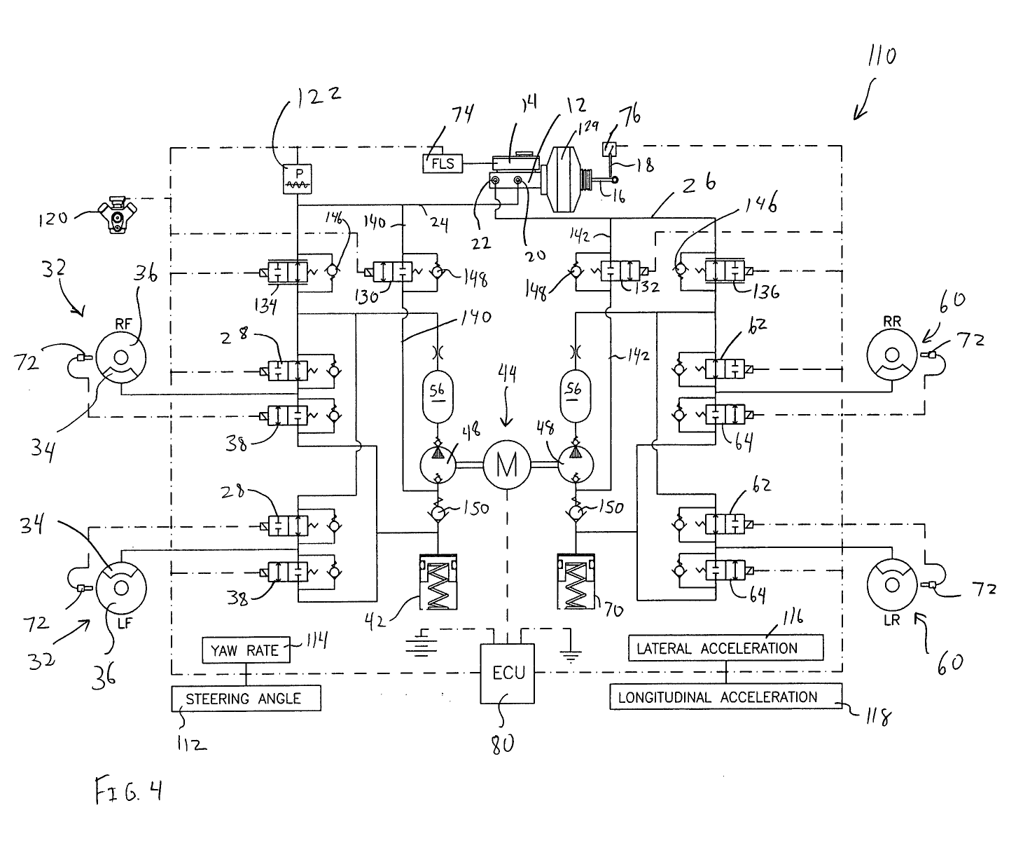

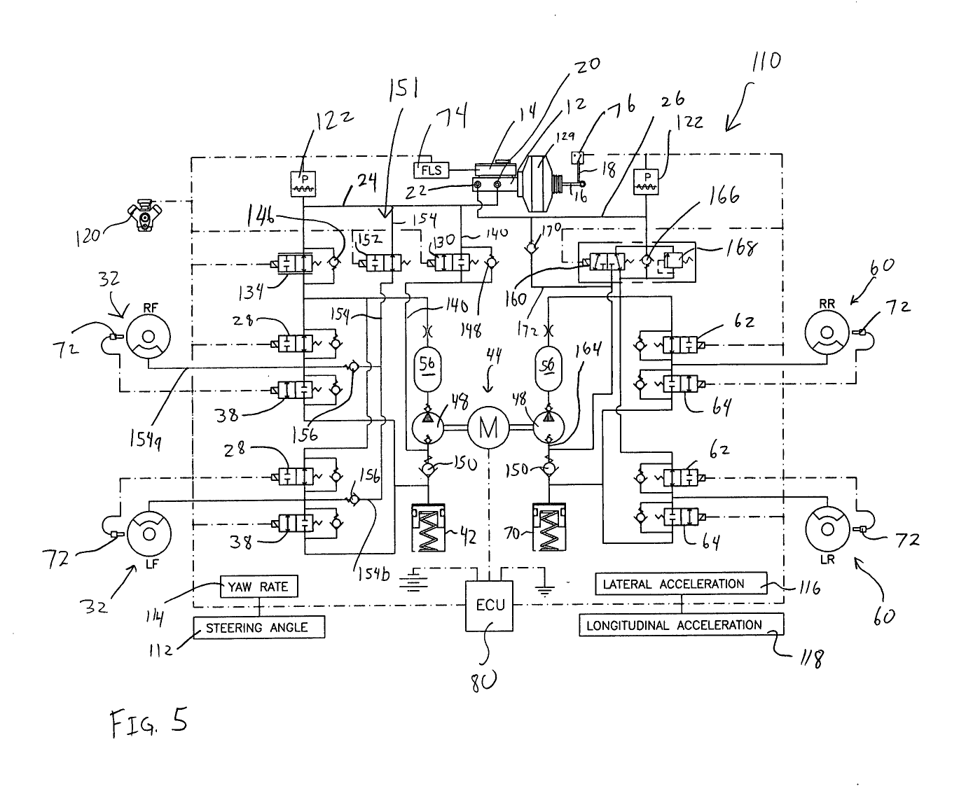

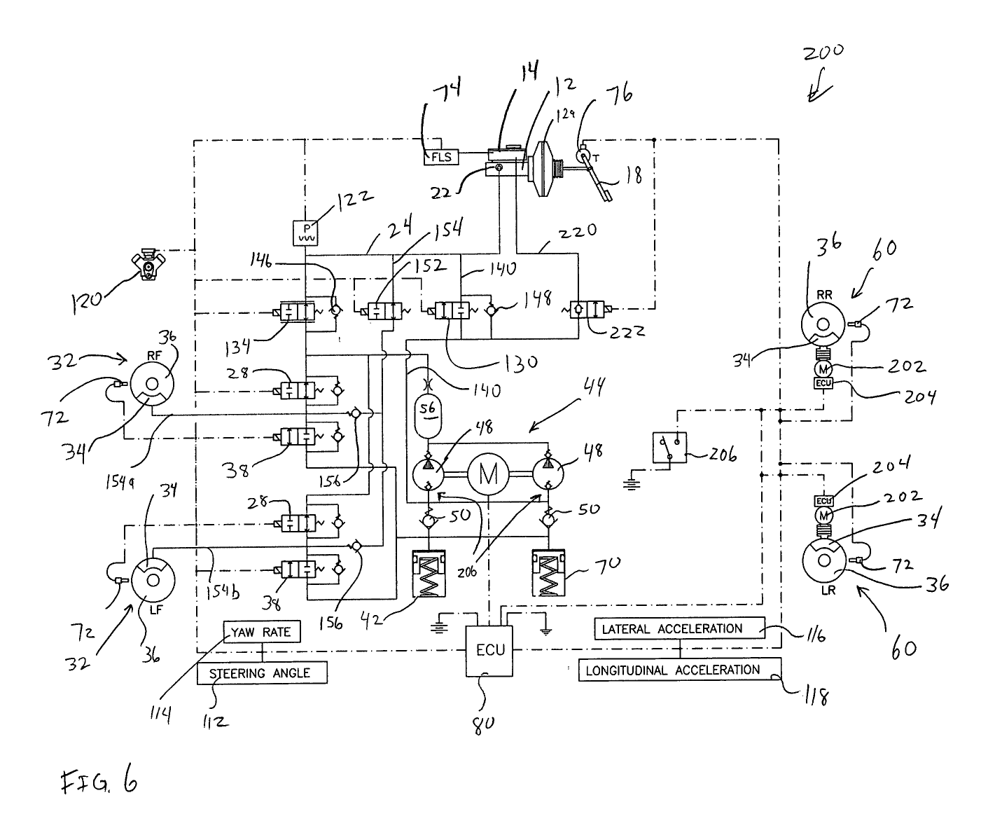

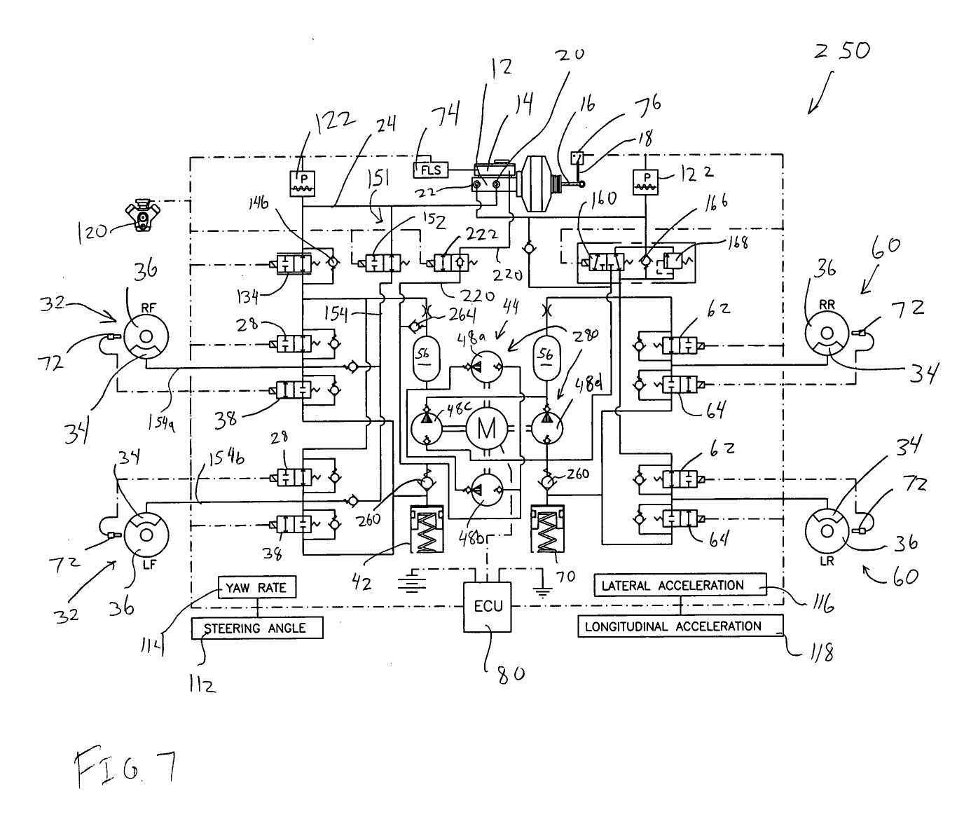

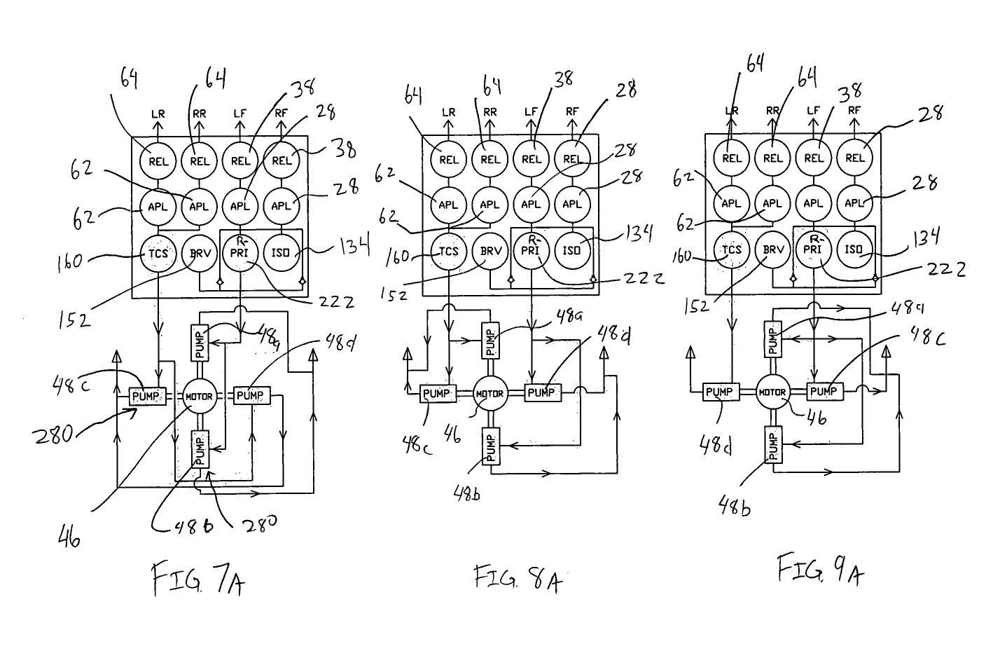

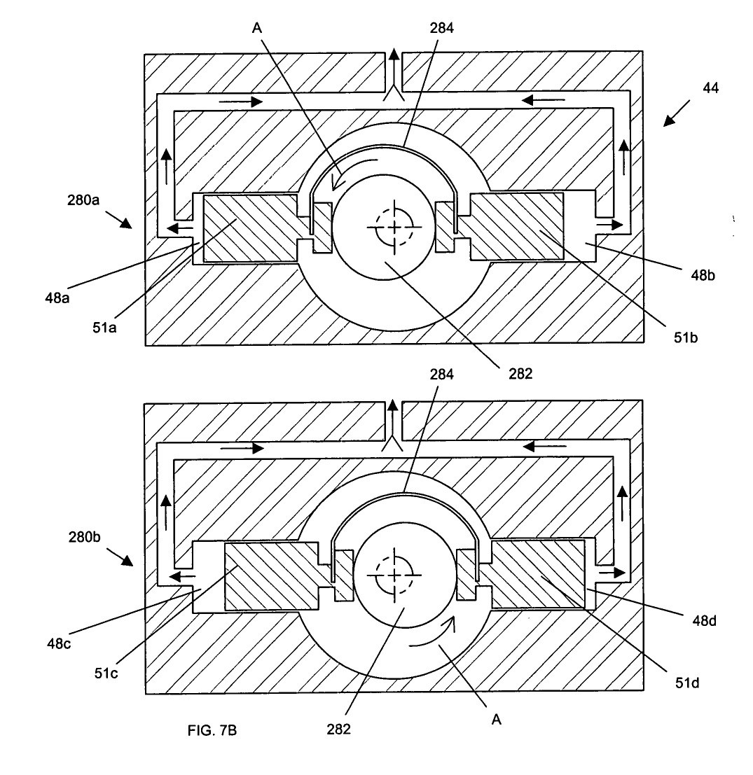

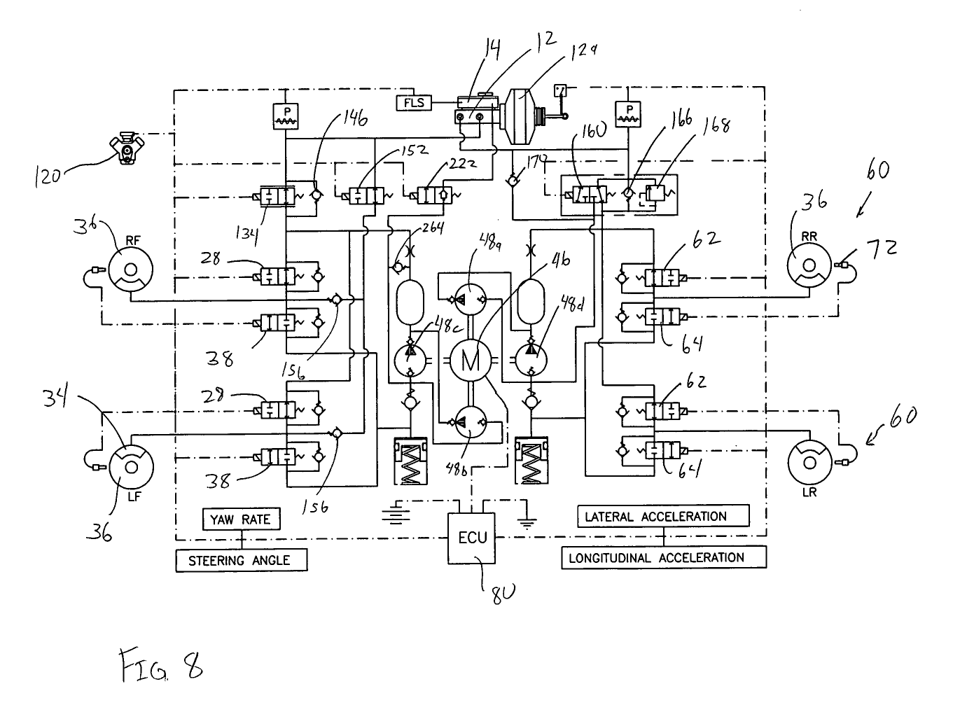

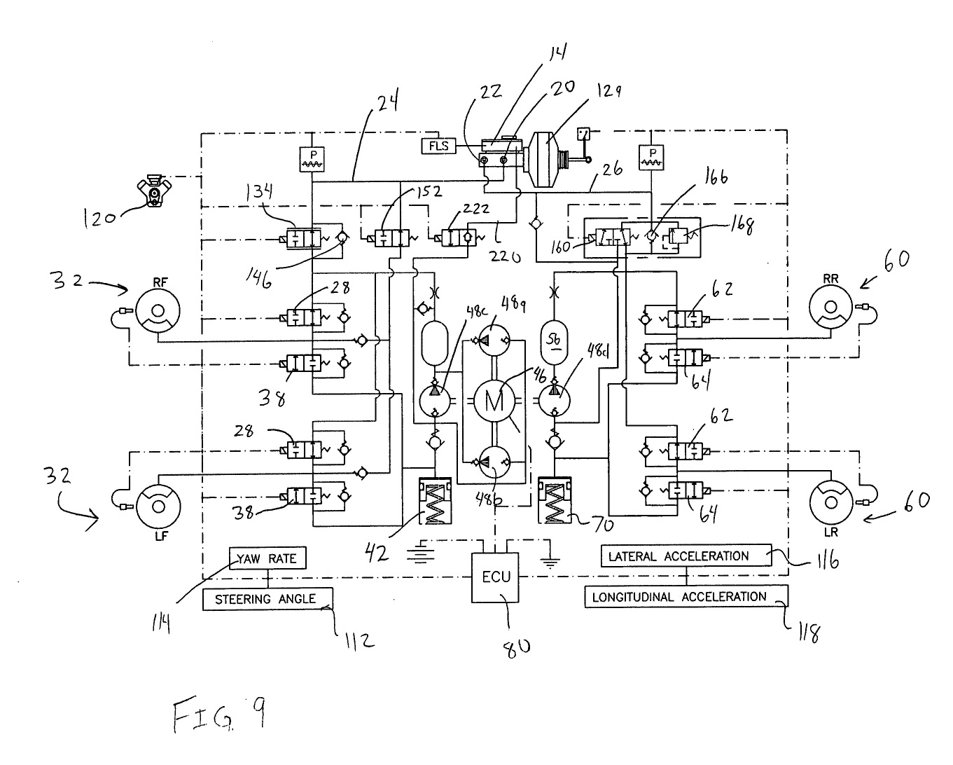

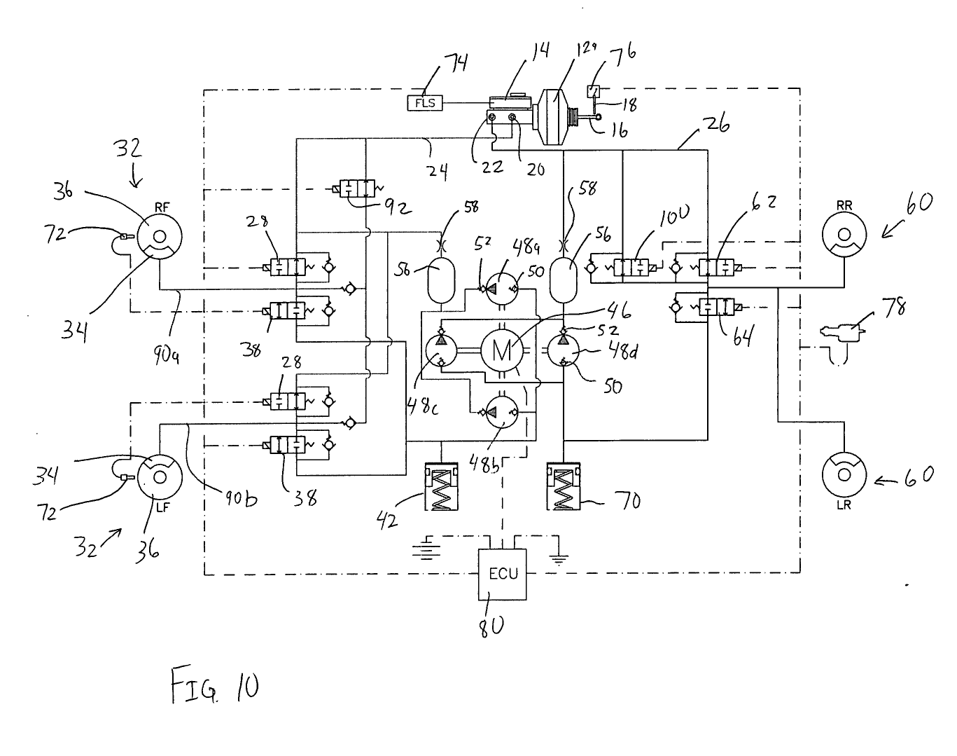

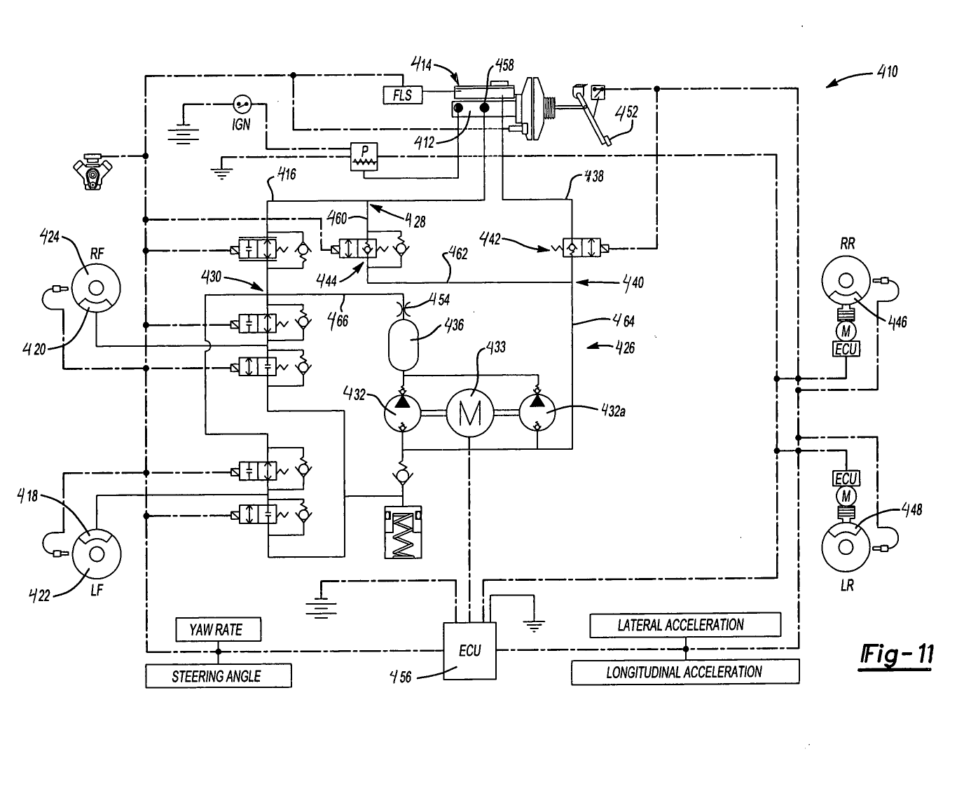

As shown in FIG. 1, a basic or baseline ABS brake system 10 includes a master cylinder 12 having a master cylinder reservoir 14 storing excess brake fluid therein. The master cylinder 12 includes a pair of pistons (not shown) located therein that are isolated from each other inside the master cylinder 12. Each piston is coupled by way of mechanical or fluid means to a rod 16 which protrudes outwardly from a brake booster 12a, which in turn activates or controls pressure in the master cylinder 12. The rod 16 is coupled to a brake pedal (not shown). The position of the rod 16 and brake pedal is monitored by brake switch 76 operatively coupled to the rod 16 by a linkage 18. The master cylinder 12, pistons, brake booster 12a, rod 16, and brake pedal are configured so that when a driver depresses the brake pedal, the rod 16 and pistons are moved (i.e., to the left in the drawing of FIG. 1), thereby pressurizing the fluid in the master cylinder 12.

The master cylinder 12 includes a pair of outlet ports 20, 22 with a primary main brake line 24 coupled to and extending from the port 20, and a secondary main brake line 26 coupled to and extending from the other port 22. Each of the primary brake line 24 and secondary main brake line 26 (also termed fluid line assemblies, or collectively a fluid line assembly), as well as other lines or conduits described herein, may include or be defined by fluid lines, fittings, line connectors, valves and the like.

Turning first to the primary brake subsystem, or front brake subsystem or circuit, fluid in the primary main brake line 24 is pressurized by one of the pistons when a driver presses the brake pedal, and the primary main brake line 24 is in fluid communication with a pair of front normally open apply valves 28. FIG. 1 schematically illustrates the apply valves 28 in their open position which allows the flow of fluid therethrough. The apply valves 28 are actuable or movable (i.e., to the right from their position shown in FIG. 1) to their closed positions to block the flow of fluid therethrough. The system includes a pair of front apply check valves 30 in parallel with the associated apply valve 28.

Fluid passing through each apply valve 28 flows to the associated front wheel brake system 32 (i.e., associated with either the right front (“RF”) or left front (“LF”) wheel). Pressurized fluid thereby causes the caliper 34 of the wheel brake system 32 to move and thereby cause the brake pad or brake pads press against the rotor of the wheel 36 to cause braking of the wheel 36 in a well-known manner.

Each wheel brake subsystem 32 and the outlet of each apply valve 28 is also in fluid communication with an associated front normally closed release valve 38. The release valves 38 are shown in FIG. 1 in their closed positions, wherein the release valves 38 block the flow of fluid therethrough. Each of the release valves 38 is actuable or movable (i.e., to the right in FIG. 1) to its open position to allow the flow of fluid therethrough. The system includes a pair of front release check valves 40, each check valve 40 being in parallel with its associated release valve 38.

The outlet of each release valve 38 is in fluid communication with a front or primary circuit accumulator 42 such that fluid flowing from the release valves 38 can flow to the primary circuit accumulator 42. The primary circuit accumulator 42 and the fluid stored therein are in fluid communication with the pump, generally designated 44. The pump 44 includes a motor 46 which reciprocally drives a pair of pistons (not shown in FIG. 1), each piston being located in a cylinder or pumping chamber 48. Each pumping chamber 48 includes an inlet check valve 50 and an outlet check valve 52 in a flow-through orientation, such that reciprocal movement of the pistons drives the fluid in the direction of arrows 54 (i.e., upwardly in FIG. 1) in the well-known manner of a positive displacement pump.

When the pump 44 is operating, fluid exits the pumping chambers 48 and enters a damper chamber 56. The pumped fluid then passes through an orifice 58 designed to restrict flow to create a controlled back pressure in damper chamber 56, which in turn reduces the amplitude of pressure pulsations of the fluid being returned to primary main brake line 24. The orifice 58 therefore reduces noise and brake pedal harshness experienced by the driver during an ABS or other controlled brake event.

The primary main brake line 24 provides fluid flow to the right front and left front wheel brake systems 32. Turning now to the rear wheels or the secondary brake system, the secondary main brake line 26 is coupled to port 22 to provide fluid flow to the rear wheel brake systems 60 associated with the right rear (“RR”) and left rear (“LR”) wheels. The fluid to the secondary main brake line 26 is pressurized by a piston located in the master cylinder that is separate from the piston that pressurizes fluid in the primary main brake line 24. In this manner, two separate, isolated hydraulic systems or brake circuits for the front and rear wheel brake systems are provided to provide a front/rear split for brake redundancy in a well-known manner. The front (primary) brake system can be considered to include all of the conduits, valves, fittings, pump portions, components etc. that are wetted by fluid flowing from port 20 and primary main brake line 24. The rear (secondary) brake system can be considered to include all of the conduits, valves, fittings, pump portions, components, etc. that are wetted by fluid flowing from port 22 and secondary main brake line 26. The front and rear brake systems can be considered, separately or together, as a fluid line assembly.

The secondary main brake line 26 is in fluid communication with a rear apply valve 62 and a rear release valve 64, and associated check valves 66, 68, which operate in a similar manner to the valves 28, 30, 38, 40 discussed above in the discussion of the primary (front) brake subsystem. In the illustrated embodiment, the rear wheel brake systems 60 are commonly controlled by a single apply valve 62 and a single release valve 64, although separate valves and separate control for each of the rear wheels may be utilized if desired. The rear release valve 64 is in fluid communication with a rear or secondary circuit accumulator 70, which provides fluid to a pumping chamber 48. Fluid passing through the pump 44 then passes through the damper 56 and damping orifice 58 of the rear system in the same manner as the front or primary system.

The brake system 10 may include a plurality of sensors to monitor the status of the vehicle. In particular, the brake system 10 may include wheel speed sensors 72 associated with the front wheels, a fluid level sensor 74 for detecting fluid level in the master cylinder reservoir 14, the brake pedal position sensor 76, and a transmission sensor 78 which measures the speed of the output shaft of the transmission to thereby provide a measurement of the average speed of the two rear wheels. Each of the sensors 72, 74, 76, 78 are operatively coupled to an electronic control unit (“ECU”) 80 which can receive and/or process inputs from the various sensors 72, 74, 76, 78. The ECU 80 is also coupled to each of the apply and release valves 28, 38, 62, 64, as well as the pump motor 46 to control and monitor these components. The ECU 80 is shaped to be mated with a hydraulic control unit (“HCU”) (not shown) which includes hydraulic controls. Thus, when the ECU 80 and HCU are mated together, they form a hydraulic and electric control unit (“EHCU”), which includes and integrates hydraulic and electronic control elements.

Existing ECU units 80 may include a limited number of input ports and/or output ports such that the ECU 80 can only monitor a number of sensors that is equal to the number of input ports, or it may be limited as to the number of output ports it can operate. For example, the ECU 80 may include only eight or twelve (or various other numbers) of solenoid output ports, each output port including a solenoid coil and the associated electronic hardware necessary to operate the coil. As shown in FIG. 1a, for an eight-coil ECU unit, the system of FIG. 1 utilizes only six of the eight coils or output ports 82 (i.e., for the release and apply valves), leaving two open output ports 82′.

During ABS control, the apply 28, 62 and release 38, 64 valves are operated to control the brake pressure applied to the associated rotors/wheels so that the applied pressure matches, as closely as possible, the pressure requested by the driver while regulating wheel slip to provide the maximum brake torque available for the given tire/road interface. Thus, the apply 28, 62 and release 38, 64 valves, as well as the pump 44, operate to control braking pressure in the well-known manner of ABS control. In particular, when it appears that a wheel is approaching a full lock condition, the associated release valve 38, 64 is moved to its open position to reduce braking pressure to reduce wheel slip. When the wheel slip level has been sufficiently reduced and it appears that braking pressure can be increased, brake pressure is incrementally increased by quickly pulsing open the associated apply valve 28, 62 while the release valves 38, 64 remain closed. The pump 48 operates continuously during the ABS cycle to return any fluid flowing from a released brake caliper 34 back to master cylinder 12. In the system shown in FIG. 1, individual ABS control is provided for each of the front wheels, and the rear wheels are commonly controlled.

The incremental increase in pressure (“pressure build-up”) implemented by opening the apply valves 28, 62 while the pump is operating and the release valves 38, 64 are closed should be precisely controlled. Accordingly, the flow orifice of the apply valves 28, 62 may be relatively small or restricted to provide for precise control during pressure buildup. However, the restricted orifice of the apply valve 28, 62 may limit the response time of braking during normal (non-ABS) braking.

The system of FIG. 2 addresses the issues raised by the restricted orifice of the front apply valves 28 through the addition of a brake response system 88, which includes a brake response conduit 90 and a brake response valve 92 located in the brake response conduit 90. In particular, the brake response conduit 90 fluidly couples the master cylinder 12 (via outlet port 20 and the primary main brake line 24) to the wheel brake systems 32 of both the right front and left front wheels. The brake response valve 92 is located in the brake response conduit 90 to control the flow of fluid therethrough. The brake response conduit 90 includes a pair of sub-lines 90a, 90b, each of which is coupled to one of the wheel brake systems 32 and includes a brake response check valve 94 located therein.

When a driver presses on the brake pedal during normal braking operations, fluid exiting port 20 and flowing through the primary main brake line 24 may flow through the brake response conduit 90 and brake response valve 92 directly to each of the wheel brake systems 32. The brake response valve 92 is a normally open valve which allows brake fluid to flow therethrough during normal brake operations. The brake response valve 92 can be moved to its closed position during controlled braking events, such as ABS operation. The brake response check valves 94 allow pressure in each of the right front and left front wheel brake systems 32 to be isolated and individually controlled, for example, during ABS operation.

The brake response valve 92, check valves 94 and brake response conduit 90 (and sub-lines 90a, 90b) may have a relatively large cross section area or orifice to allow for quicker response times and greater braking forces in shorter times. This can allow the braking system to be used on heavier vehicles (for example light trucks) without resizing the existing valves and components, although the brake response system 88 can also be used with cars or other vehicles. For example, the apply valve 28 may have a circular orifice having a diameter of about 0.7 mm. The brake response valve 92 may have a diameter of, for example, between about 0.85 mm and about 1.0 mm (or greater) and the brake response conduit 90 and check valves 92 may have an even larger diameter. Because the flow through an orifice is related to its cross-sectional area, in this case a 0.85 mm brake response valve 92 provides an area that is about 1½ times greater than that of the 0.7 mm of the apply valve 28, while a 1.0 mm brake response valve 92 provides an area that is about 2 times greater than that of the 0.7 mm of the apply valve 28.

During normal braking, brake fluid may flow through both the apply valve 28 and the brake response valve 92. Thus, the brake response system 88 provides an additional flow path parallel to the flow path provided through the apply valves 28 and allows significantly increased flow of brake fluid during braking. This allows for a larger volume flow rate from the master cylinder 12 to the wheel brake systems 32, and provides a quicker response time. Further, during controlled braking operations such as ABS, the brake response valve 92 can be closed to allow pressure to be generated, controlled and/or modulated in the primary brake system. Although the brake response system 88 is illustrated in FIG. 2 in conjunction with a brake system having a front/rear split, the brake response valve 92 and system 88 may also be used in a brake system having a diagonal split or other arrangements. The brake response valve 92 may be an infinitely adjustable, linear valve that can regulate flow in proportion to applied current. Alternately, the brake response valve 92 may be a simpler “on/off” valve which is pulsed closed with full voltage or otherwise maintained in the fully open position.

FIG. 2 illustrates the brake response conduit 90 as having a pair of sub-lines 90a, 90b. However, rather than having two sublines 90a, 90b which share a common source line 90 and both of which are controlled by brake response valve 92, each of the wheel brake systems 32 may have its own, dedicated brake response conduit and brake response valve. In this case, each of the sub-lines 90a, 90b may be directly coupled to the master cylinder 12 and to the primary main brake line 24, and each sub-line may have a controllable brake response valve located therein.

FIG. 2a illustrates the valve output coil or output port setup of an ECU 80 of the system of FIG. 2. As can be seen, the addition of the brake response valve 92 utilizes one of the empty output ports 82′ of the system of FIG. 1a. The systems of FIG. 2 and 2a only utilize 7 output ports of the ECU and thus can be easily accommodated into many ECUs.

FIG. 3 illustrates the system of FIG. 2, with an additional brake response system 98 in the form of rear brake response valve 100 and rear brake response conduit 102 coupled to the secondary main brake line 26 and to the rear wheel brake systems 60 to provide an additional flow path to the rear wheels. Accordingly, this rear brake response system 98 provides the same advantages (in the form of increased flow of brake fluid to the rear wheel brake systems 60 during normal braking) as the brake response system 88 discussed above in the context of FIG. 2. Further, the system of FIG. 3 utilizes eight controllable valves 28, 38, 92, 100, 62, 64, and thus can still be easily accommodated in the ECU 80 shown in FIGS. 1a and 2a.

FIG. 4 illustrates a brake system 110 utilizing electronic stability control (“ESC”), also referred to as vehicle stability enhancement (“VSE”) or an electronic stability program (“ESP”), which is an electromechanical control system designed to monitor and influence wheel dynamics, and ultimately vehicle dynamics, during a vehicle state of braking, accelerating or coasting (termed ESC for the purposes of this application). ESC typically uses input from wheel speed sensors 72, a steering wheel angle sensor 112, a yaw rate sensor 114 and a lateral acceleration sensor 116 and optionally a longitudinal acceleration sensor 118 to determine the driver's intended heading and the vehicle's actual heading. ESC may be designed to identify the intent of a driver by measuring the steering wheel angle, brake and throttle positions and vehicle speed. The ESC typically controls the application of a brake on a single wheel, as necessary, to help a driver regain control in a skid caused by oversteering or understeering on a curve, but also can operate to provide control and vehicle guidance in various other manners.

In order to accommodate the ESC system, various sensors beyond the sensors of the systems of FIGS. 1-3, including the yaw rate sensor 114, steering angle sensor 112, a lateral acceleration sensor 116, and longitudinal acceleration sensor 118 may be utilized and operatively coupled to the ECU 80. In addition, an engine throttle control 120 and pressure sensor 122, which monitors the pressure of the brake fluid, may be utilized and operatively coupled to the ECU 80. Finally, in the embodiment shown in FIG. 4, both of the rear wheels also include wheel individual speed sensors 72.

The brake system shown in FIG. 4 includes a pair of prime valves 130, 132 and a pair of isolation valves 134, 136. Each prime valve 130, 132 is coupled to the associated main brake line 24, 26 such that fluid can flow from the master cylinder 12 to the inlet of the pump 44 via the associated prime conduit 140, 142. Each prime valve 130, 132 is a normally closed valve and each isolation valve 134, 136 is a normally open valve. Each isolation valve 134, 136 is placed in the associated main brake line 24, 26 to allow or block the flow of fluid between the master cylinder 12 and the associated apply valves 28, 62 and wheel brake systems 32, 60.

The brake system 110 of FIG. 4 further includes a pair of isolation check valves 146, with each isolation check valve 146 being in parallel with the associated isolation valve 134, 136. The system 110 also includes a pair of prime check valves 148, with each prime check valve 148 being in parallel with the associated prime valve 130, 132. The system 110 further includes a pair of external pump check valves 150, with each external pump check valve 150 being located between one of the accumulators 42, 70 and the input of the associated pump chamber 48.

When utilizing the ESC system in a traction control cycle, it is generally desired to apply brake pressure to an excessively spinning wheel during acceleration to thereby cause torque to transfer to the other wheel on the same axle in a well-known manner. Thus, this type of pressure build mode requires brake fluid to flow from the master cylinder 12 to the appropriate apply valves 28, 62 and associated wheel brake systems 32, 60 without any user input.

In order to operate in a traction control mode, for example to control the front brakes in a side-to-side torque distribution, the prime valve 130 is moved to its open position and the pump 44 is operated to pump fluid from the master cylinder 12 to the inlet of the pump chamber 48, and then to move the fluid through one of the opened apply valves 28 to the associated wheel brake system 32. Simultaneously, the isolation valve 134 is moved to its closed position to allow the system to pressurize since the master cylinder 12 is typically vented to atmosphere when the brakes are not applied by the driver. Thus, the isolation valve 130 and prime valve 134 operate in tandem, such that actuation or opening of the prime valve 130 normally accompanies actuation (i.e., at least a partial closing) of the isolation valve 134.

In the illustrated embodiment, the isolation valve 134 is a variable or infinitely adjustable valve so that pressure and flow through the isolation valve 134 can regulated in proportion to the current supplied to its associated solenoid coil. This variable nature of the isolation valve 134 allows the back pressure in the system to be maintained at the desired level during operation of the traction control cycle. The apply 28 and release 38 valves may also be operated to ensure that the correct and desired brake pressure is applied to the associated wheel (i.e., to reduce slippage and to transfer torque in the well-known manner of TCS operation).

Operation of the isolation valve 136, prime valve 132, apply valves 62 and release valves 64 for the rear brake circuit during traction control mode is generally the same as that described above for the front brake circuit. The system of FIG. 4 provides individual ABS control (in the form of apply valves 62, release valves 64, and associated components) for each of the rear wheels. The rear isolation valve 136 may also be a variable valve to provide similar control of brake pressure as described above.

As shown in FIG. 4a, the brake system of FIG. 4 utilizes twelve controllable valves; that is, two front apply valves 28, two front release valves 38, two rear apply valves 62, two rear release valves 64, a front prime valve 130, a rear prime valve 132, a front isolation valve 134, and a rear isolation valve 136. Thus the ECU 80 requires twelve output ports 82 each including a solenoid valve coil and its associated electronic drivers to control the twelve active valves of the system 110 of FIG. 4a. Accordingly, if it is desired to add a brake response system with a brake response valve (similar to the systems of FIGS. 2 and 3) while using the same ECU unit, changes to the configuration of the system of FIG. 4 must be implemented.

FIG. 5 illustrates the system 110 of FIG. 4 modified to include a brake response system 151 (including a brake response valve 152, a brake response conduit 154, a pair of sub-conduits 154a, 154b and check valves 156) incorporated into the front brake system. This brake response system 151 allows fluid to flow from the master cylinder 12 to the brake subsystems 32 for the right front and left front wheel, much in the manner shown in FIG. 2 and in the accompanying description.

The addition of the brake response system 151 to the system 110 of FIG. 4, without any additional changes, would increase the total number of the valves of the system of FIG. 4 to thirteen valves. However, the ECU 80 utilized with the system of FIG. 4 may include only twelve solenoid valve coil output ports, and therefore some redesign may be required in order to accommodate the additional controllable valve in the form of the brake response valve 152.

In order to accommodate the brake response valve 152, the prime valve 132 and isolation valve 136 for the rear brake system of FIG. 4 may be combined into a single two-position three-way valve 160. The three-way valve 160 is biased into the position shown in FIG. 5. Thus, during normal braking operations, the secondary main brake line 26 and port 22 of the master cylinder 12 are in fluid communication with both rear apply valves 62 and the associated wheel brake systems 60 so that the brake system 110 may operate in its normal manner. In this configuration the inlet of the pump 44 is not in direct fluid communication with the master cylinder 12.

In contrast, when rear TCS braking action is required, the three-way valve 160 shifts to the right from its position shown in FIG. 5, such that the secondary main brake line 26 is in fluid communication with pump inlet line 164 to provide a direct line of fluid communication from the master cylinder 12 to the inlet of the pump 44. Furthermore, when the three-way valve 160 is in its activated position, the secondary main brake line 26 and master cylinder 12 are isolated from the apply valves 62 and associated wheel brake systems 60, which allows pressure to be generated in the rear brake system during TCS operations.

The system of FIG. 5 includes a check valve 166 and a mechanical blow-off valve 168 in parallel with the three-way valve 160. The blow-off valve 168 allows excess pump pressure to escape across the three-way valve 160 when sufficient pressure is generated by pump 48. The blow-off valve 168 operates as a release or a check valve and sets a constant back pressure as opposed to the variable back pressure which can be provided by the isolation valves 136 or 134. The system of FIG. 5 also includes a check conduit 172 with a check valve 170 located therein. The check conduit 172 extends from the secondary main brake line 26 to the outlet of the three-way valve 160 and the pump inlet line 164 and allows for the pump inlet circuit to be evacuated of any entrapped air during assembly plant installation by use of industry standard evacuate-and-fill procedures.

Accordingly, the three-way valve 160 of FIG. 5 can serve as a substitute of the separate rear isolation valve 136 and rear prime valve 132 of FIG. 4. However, the three-way valve 160 provides lesser control as compared to separate isolation 136 and prime 132 valves. For example, as noted above, the isolation valve 136 of FIG. 4 may be a variable valve to provide greater control of the backpressure in the system that can result in lower noise levels and higher operating efficiencies. In contrast, the three-way valve 160 does not provide variable pressure control. However, incorporation of a fixed blow-off pressure is a cost-effective means of providing system pressure control and may be perfectly adequate, particularly for rear wheel pressure control that may have less stringent control requirements.

FIG. 5a is a schematic representation of the valve layout of the system of FIG. 5. As can be seen, the three-way valve 160 (labelled “TCS” in FIG. 5a) provides control to both the left rear and right rear wheel brake systems, and allows control utilizing only twelve output ports 82 of the ECU 80.

FIG. 6 is a schematic representation of a hybrid brake system 200. In particular, in a system of FIG. 6, the rear wheel brake systems are completely electronically controlled for example, such as in a brake-by-wire system. In this manner, the rear wheel brake subsystems incorporate electromechanical devices to actuate the rear wheel brakes. Thus, each rear brake subsystem 60 includes a motor 202 which can be actuated by its associated remote ECU 204 to cause to its associated caliper 34 to engage the associated rotor 36 and cause braking. Each rear wheel ECU 204 is operatively coupled to the main ECU 80, and is also coupled to a safety switch 206 that is connected to ground.

The front brake system is a hydraulically controlled system. The system of FIG. 6 includes a brake response conduit 154 and sublines 154a, 154b connected to the right front and rear front wheel brake subsystems 32, a brake response valve 152 located in the brake response conduit 154, and brake response check valves 156 located in the sublines 154a, 154b.

Because the rear wheel brake subsystems 60 are electronically controlled, the pump 44 does not supply any brake fluid to the rear brake circuit. Accordingly, in the system of FIG. 6, the outlet of both of the pumping chambers 48 are commonly fed to a single damper 56, which then feeds the brake fluid into the front brake system or brake circuit for the front wheels. Accordingly, the pump 44 provides two pressure pulses to the front system per each motor revolution which results in smoother operation. The pump 44 may also be easily sized for additional flow, thereby providing quicker response times.

When utilizing the traction control mode, it is desired to provide a high volume rate of flow to the inlet of the pump 44 to thereby provide brake fluid to the brake subsystems as quickly as possible. In many existing brake systems, for example, the system shown in FIG. 4, fluid is provided to the inlet of the pump via the prime conduit 140 and prime valve 130. However, due to limitations of the system such as internal restrictions in the master cylinder 12, brake pipe sizing limitations, the orifice and/or surface area of the prime valve 130 or prime conduit 140 may be relatively low, which limits the flow of brake fluid to the inlet of the pump 44. In particular, during cold weather applications, the viscosity of brake fluid increases significantly, which can adversely affect the flow rate of brake fluid to the pump inlet via the prime valve 130.

Accordingly, the system of FIG. 6 addresses this issue by the presence of a reservoir conduit 220 extending from the reservoir 14 of the master cylinder 12 to the inlets for both pumping chambers 48 (which inlets are collectively termed a pump inlet 206). The reservoir conduit 220 includes a reservoir prime valve 222 located therein to selectively control the flow of fluid from the reservoir 14 to the inlet of the pump 44. The diameter (or cross sectional area) of the reservoir conduit 220 and the reservoir prime valve 222 may be relatively large to allow high volume flow of brake fluid from the reservoir 14 to the pump 44 since the reservoir always remains at atmospheric pressure levels.

The reservoir prime valve 222 may be a two-position valve that is biased into its closed position. During TCS or other controlled brake pressure build operations, the reservoir prime valve 222 may be moved to its open position to allow the flow of fluid from the reservoir 14 to the pump inlet 206. Furthermore, because the reservoir conduit 220 is in fluid communication with the reservoir 14, pumping efficiency may be increased because the pump 44 does not have to pull against any pressure in the master cylinder 12 due to the fact that the reservoir 14 is vented to atmosphere. However, if desired the reservoir conduit 220 may instead, or in addition, be coupled to the master cylinder 12.

The reservoir prime valve 222 may be a poppet valve that is biased into its closed position. In other words, the valve 222 as a whole may be a poppet valve and may be operate in the same manner as, for example, valve 152, even though the schematic representation of valve 222 is slightly different from that of valve 152. The poppet valve 222 may be activated and opened to allow an additional flow of fluid during start up of the pump or during priming when the highest flow rates are desirable. However, as the system nears its target pressure, the reservoir prime valve 222 may be de-activated and closed to avoid system over-pressurization.

FIG. 7 represents somewhat of a combination of the system of FIG. 5 and FIG. 6. In particular, the system 250 of FIG. 7 includes the brake response system 151 for the front wheels and the three-way valve 160 for the rear wheels similar to the system of FIG. 5. Further, the system 250 of FIG. 7 includes the reservoir conduit 220 and reservoir prime valve 222 of FIG. 6 to provide rapid pumping response to the primary (front) brakes. In particular, in the system of FIG. 7 the reservoir prime valve 222 of FIG. 6 has replaced the master cylinder prime valve 130 of the system of FIG. 5. The master cylinder prime valve 130 may be omitted in the system of FIG. 7 order to retain the overall number of valves in the system at twelve in order to accommodate the twelve solenoid coil output ports in the ECU 80.

The reservoir prime valve 222 may be used instead of the master cylinder prime valve 130. However, because the reservoir prime valve 222 is coupled to the reservoir 14 and the reservoir 14 is vented to the atmosphere, changes in the control of pressure in the system are required to accommodate the change from a master cylinder prime valve 130 (FIG. 5) to a reservoir prime valve 222 (FIG. 7). Further, the system 250 of FIG. 7 includes check valves 260 that communicate with the outlet of the associated accumulator 42, 70. The system 250 of FIG. 7 also includes a check valve 264 in communication with the outlet of the front damper 56 and the reservoir conduit 220, which allows for the pump inlet circuit to be evacuated of any entrapped air during assembly plant installation by use of industry standard evacuate-and-fill procedures.

The system of FIG. 7 further includes a pump arrangement 44 configured to provide additional pumping power. In particular, the pump system 44 shown in FIG. 7 has four cylinders (pumping chambers) 48a, 48b, 48c, 48d, with a piston 51a, 51b, 51c, 51d reciprocally disposed inside its associated cylinder 48a, 48b, 48c, 48d. For example, FIG. 7b illustrates a pair of pump units 280a, 280b, with each pump unit 280 including two opposed pistons 51, each piston 51 being slidably received in an associated cylinder 48. Each piston 51 is coupled to a driveshaft eccentric 282 by an associated retainer 284. During operation, the eccentric 282 is rotated in the direction of arrow A to cause the pistons 51 to reciprocate in the associated cylinders 48. The pistons 51 of a given pump unit 280a, 280b are offset such that, for example, when piston 51a (or 51c) is in its fully extended position, the opposing piston 51b (or 51d) is in its fully retracted position. Thus the pistons 51 of a single pump unit 280 are offset one hundred and eighty degrees.

Each pump unit 280 may be commonly coupled to the same driveshaft eccentric 282. In the embodiment shown in FIG. 7b, the two pump units 280 are one hundred and eighty degrees out of phase such that, for example, when piston 51a is in its extended position piston 51c is in its retracted position, and when piston 51a is in its retracted position piston 51c is in its extended position. However, if desired the pump units 280 may be in phase such that the piston 51a and piston 51c move together. The pump units 280 may also out of phase by varying amounts besides one hundred eighty degrees, including ninety degrees, two hundred and seventy degrees, or other varying degrees. In the arrangement shown in FIG. 7b the pump units 280 are one hundred eighty degrees out of phase which provides mechanical balance and a relatively constant inlet vacuum and outlet pressure source. FIG. 7a schematically illustrates the system of FIG. 7.

The system of FIGS. 7, 7a and 7b includes four pistons 51 and cylinders 48. In the illustrated embodiment, pumping cylinders 48c and 48d are in fluid communication with the rear wheel brake system or circuit to provide pressurized brake fluid thereto, and cylinders 48a and 48b are in fluid communication with the front wheel brake system or circuit. Because the pistons 51 of a single pump unit 280 are one hundred eighty degrees out of phase, a relatively constant pressure source is provided. If desired, cylinders 48a and 48c may be coupled to one of the brake circuits, and cylinders 51b and 51d may be coupled to the other brake circuit. Because pistons 51a and 51c are one hundred eighty degrees out of phase, as are pistons 51b and 51d, a relatively constant pressure source can also be supplied in this manner. Thus in the pumping arrangement shown in FIG. 7, the pump units 280 are one hundred eighty degrees out of phase, and the pistons 51 that are coupled to a single line are also one hundred and eighty degrees out of phase. However, the system of FIG. 7 may be configured such that the pumping units are in phase or out of phase by varying degrees.

FIG. 8 illustrates the system of FIG. 7, with the exception that the arrangement of the pumping elements/pistons has been modified. In particular, pumping elements/pistons and cylinder 48a/51a and 48d/51d provide pressure to the rear brake subsystem, and pumping elements/pistons and cylinders 48c/51c and 48b/51b provide pressure to the front brake subsystem.

Furthermore, in the arrangement of FIG. 8 the pumping units 280a, 280b may be ninety degrees out of phase, rather than the one hundred eighty degrees out of phase shown in FIG. 7b. In other words, when the pistons 51a, 51b of one pumping unit 280a are fully extended/retracted, the pistons 51c, 51d of the other pumping unit 280b are located the midpoint of their stroke. This ninety degree out-of-phase arrangement provides for more efficient mechanical performance because the pistons 51 are not pulling/pushing against the maximum torque. However, the system of FIG. 8 may be configured such that the pumping units 280a, 280b are in phase or out of phase by varying degrees.

FIG. 9 illustrates yet another arrangement of the pumping elements. In the system of FIG. 9, three of the pistons or pumping elements 48a, 48b, 48c provide pressure to the front brake subsystem, and only a single piston or pumping element 48d provides pressure to the rear brake subsystem. This “3+1” arrangement of pumping elements maximizes performance of the front brake subsystem, which typically carries a great proportion of the braking load. In the system of FIG. 9 the pumping units 280 may be in phase or out of phase by varying degrees.

FIG. 10 illustrates a brake system utilizing front 92 and rear 100 brake response valves, similar to the system of FIG. 3. However, the system of FIG. 10 includes four pumping elements or pistons 48a, 48b, 48c, 48d arranged in a one hundred eighty degree offset, similar to the system of FIG. 7. Of course, any of the arrangements of pumping elements, arrangement of brake response systems and reservoir prime valves may be utilized in nearly any combination disclosed herein.

FIGS. 7-10 illustrate the pumping units 280 in and out of phase by varying degrees, and the pistons 51 can be arranged to provide pressure to varying brake circuits. Thus it can be seen that the phase of the pumping units 280 and the connections of the pistons 51 to the brake circuits can be varied in a wide variety of manners to achieve the desired performance with known trade-offs.

Referring now to FIG. 11, the invention provides a braking system 410 for a vehicle. The system 410 includes a master cylinder assembly including master cylinder 412 in communication with a reservoir 414. A first fluid path or line 416 extends between a primary port 458 of the master cylinder 412 and one or more brakes 418, 420 disposed at respective wheels 422, 424. The line 416 can be defined by fluid lines, fittings, line connectors and valves. In the exemplary embodiment of the invention, the first fluid line 416 is part of a master cylinder primary circuit. A master cylinder to wheel circuit isolation valve and a plurality of wheel brake apply valves are shown positioned along the fluid line 416. The braking system 410 is shown as a Front/Rear/Rear system wherein both front brakes are controlled by a single circuit and rear, electrically-actuated brakes 446, 448. However, the invention is not limited to the exemplary embodiment shown but can be incorporated with any configuration of braking system including a pre-charge.

A second fluid path or line 426 extends between a first position 428 along the first fluid line 416 and a second position 430 along the first fluid line 416. In the exemplary embodiment of the invention, the second fluid line 426 includes line portions 460, 462, 464, 466. A master cylinder to pump prime valve 444 is disposed between line portions 460 and 462. Line portions 462 and 464 are fluidly connected to one another at point 440. Pumps 432 and 432a are disposed in parallel to one another between line portions 464 and 466. A pump damper chamber 436 and an orifice 454 are shown disposed along the second fluid line 426, and more specifically between line portion 466 and the pumps 432, 432a. The pump damper chamber 436 and the orifice 454 can reduce the amplitude of pressure pulsations passing through the system 410. Pressurized brake fluid is delivered to the line portion 466 by the pumps 432 and 432a through the damper chamber 436 and orifice 454. Fluid is pressurized by the pumps 432, 432a and is therefore at a higher pressure in line portion 66 than in line portions 462, 464 during operation of the pumps 432, 432a.

Each of the plurality of pumps 432, 432a defines a repeating operating cycle in which fluid is drawn into the pumps 432, 432a at a first pressure and is urged out of the pumps 432, 432a at a second, higher pressure. The operation of each pump 432, 432a is controlled such that the operating cycles of the pump are offset with respect to one another. For example, the fluid pump 432 can be urging pressurized fluid to the line portion 466 while the fluid pump 432a is drawing fluid from the line portion 464.

The pumps 432, 432a can be sized similar to a single pump used in prior art systems and be modified to deliver an equivalent flow rate. For example, the pumps 432, 432a can be piston pumps and the stroke of the piston in each of the pumps 432, 432a can be approximately one-half the stroke of a piston of single pump. The single pump would generate greater displacements of fluid for each stroke as compared to each of the individual pumps 432, 432a, resulting in relatively greater fluid pressures during each stroke. In other words, the single pump of the prior art system would generally generate half the pressure pulsations of the pair of pumps 432, 432a, however, the amplitude of each pulsation would be greater than the amplitude of individual pulsations generated by each of the pumps 432, 432a.

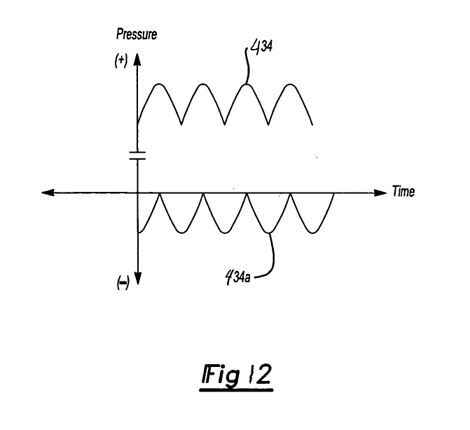

In operation, offsetting the operating cycles of the pumps 432, 432a substantially reduces the amplitude of fluid pressure pulsations passing through the system 410, especially at a brake pedal 452 of the system 410. FIG. 12 is a graph schematically showing a first line or truncated wave 434 generally representing fluid pressure in the line portion 466 during operation of the system 410. The x-axis demarcates time. The line 434 defines a plurality of cycles, each cycle starting when the line 434 is at a minimum pressure value and ending after the line 434 has reached a maximum pressure value and returned to the minimum pressure value. Every other cycle corresponds to the pressure increase in the fluid line 466 associated with one of the pumps 432, 432a discharging pressurized fluid to the line 466. Adjacent cycles correspond to a first of the pumps 432, 232a discharging fluid and a second of the pumps 432, 432a discharging fluid.

In the prior art methods using a single pump, a graphical line representing pressure at the single pump outlet defines gaps between adjacent cycles since pressurized fluid is not delivered to the fluid line portion downstream of the single pump when the single pump is drawing fluid to be pressurized. In addition, the amplitude of a cycle in the prior art pressure graph is greater than the amplitude of the cycles defined by line 434 since the flow rate demanded of the prior art system must be satisfied by fewer pump discharges. In other words, the amplitude of the line 434 is reduced by the arrangement of a plurality of pumps 432, 432a arranged in parallel to one another. For example, the amplitude of a cycle of the line 434 is approximately one half of the amplitude of a cycle of a graphical line representing pressure in a prior art, single pump system.

A second line 434a represents the fluid pressure in the line portion 464 during operation and corresponds to vacuum created when the pumps 432, 432a draw fluid. Another benefit of the present invention is that vacuum at the inlet of the pumps 432, 432a is more consistent. The line 434a defines a plurality of cycles, each cycle starting when the line 434a is at a maximum pressure value and ending after the line 434a has reached a minimum pressure value and returned to the maximum pressure value. Every other cycle corresponds to the pressure decrease in the fluid line 464 associated with one of the pumps 432, 432a drawing fluid from the line 464. Adjacent cycles correspond to a first of the pumps 432, 432a drawing fluid and a second of the pumps 432, 432a drawing fluid. At least one of the pumps 432, 432a is likely drawing fluid at all times. The wave 434a is closer to the x-axis since the negative pressure or vacuum in the line portion 464 is not as great as the pressure of fluid in the line portion 466.

In the prior art methods using a single pump, a graphical line representing pressure at the single pump inlet defines gaps between adjacent cycles since fluid is not drawn from the fluid line portion upstream of the single pump when the single pump is discharging pressurized fluid. In addition, the amplitude of a cycle in the prior art pressure graph is greater than the amplitude of the cycles defined by line 434a since the flow rate demanded of the prior art system must be satisfied by fewer pump discharges. In other words, the amplitude of the line 434a is reduced by the arrangement of a plurality of pumps 432, 432a arranged in parallel to one another. For example, the amplitude of a cycle of the line 434a is approximately one half of the amplitude of a cycle of a graphical line representing pressure in a prior art, single pump system. Maintaining a more steady vacuum at the inlet of the pumps 432, 432a, as provided by the present invention, substantially reduces energy losses associated with starting and stopping a fluid stream moving through the various fluid paths extending between the master cylinder 412 or reservoir 414 and the pumps 432, 432a which results in improved pump flows and operating efficiencies.

In one embodiment of the invention, the operating cycles are offset 180 degrees from one another. In other words, one of the pumps 432, 432a is drawing fluid while the other pump 432, 432a is urging fluid to the brakes 418, 420. However the invention can be practiced wherein the operating cycles 434, 434a are offset less than 180 degrees from one another. The operating cycles of the plurality of pumps 432, 432a are controlled to minimize pressure pulsations.

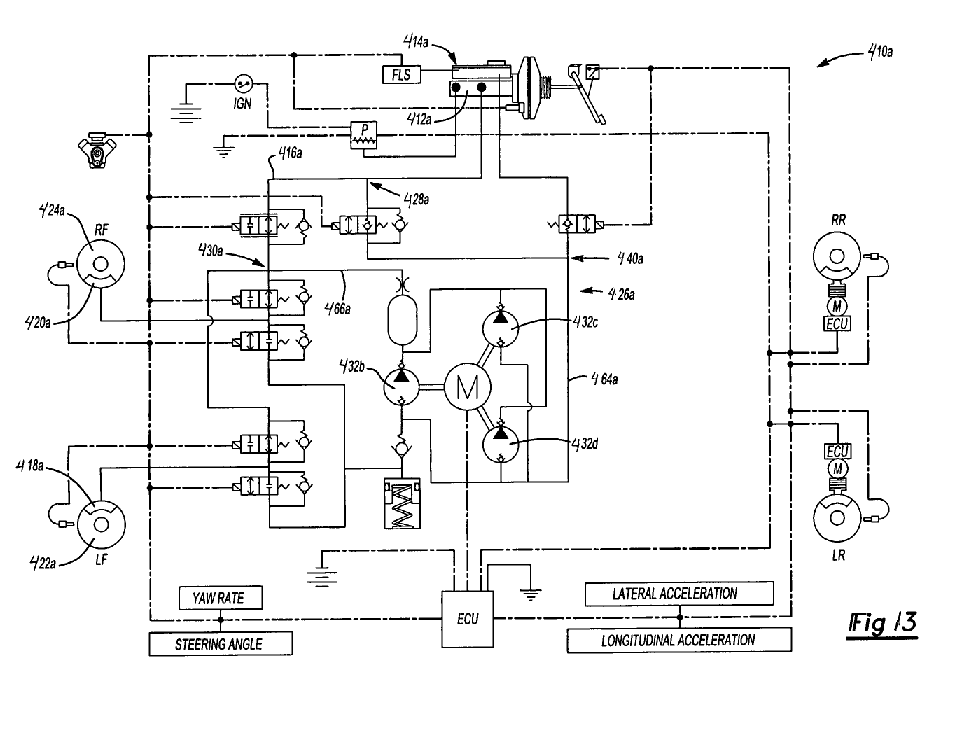

FIG. 13 shows a second exemplary embodiment of the invention including three pumps 432b, 432c, 432d. The brake system 410a includes a master cylinder 412a communicating with a reservoir 414a. A first fluid line 416a extends between the reservoir 414a and one or more brakes 418a, 420a disposed at wheels 422a, 424a. A second fluid line 426a extends between a first position 428a along the first fluid line 416a and a second position 430a. The plurality of fluid pumps 432b, 432c, 432d are disposed in parallel with respect to one another along the second fluid line 426a.

Each of the pumps 432b, 432c, 432d defines a repeating operating cycle in which fluid is drawn into the pump 432b, 432c, 432d at a first pressure and is urged out of the pump 432b, 432c, 432d at a second, higher pressure. The operating cycles of the pumps 432b, 432c, 432d can be offset 120° from one another. For example, two of the pumps 432b, 432c, 432d can be drawing fluid while the third of the pumps 432b, 432c, 432d can be urging fluid to the brakes 418a, 420a. The operation of the pumps 432b, 432c, 432d can be controlled so that the fluid pressure in line portions 466a, 464a varies over time as shown by lines 434, 434a, respectively, in FIG. 12.

The pumps 432b, 432c, 432d can be sized similar to a single pump used in prior art systems and be modified to deliver an equivalent flow rate. For example, the pumps 432b, 432c, 432d can be piston pumps and the stroke of the piston in each of the pumps 432b, 432c, 432d can be approximately one-third the stroke of a piston of single pump. The single pump would generate greater displacements of fluid for each stroke as compared to each of the individual pumps 432b, 432c, 432d, resulting in relatively greater fluid pressures during each stroke. In other words, the single pump of the prior art system would generally generate one third of the pressure pulsations of the three pumps 432b, 432c, 432d, however, the amplitude of each pulsation would be greater than the amplitude of the individual pressure pulsations generated by each of the pumps 432b, 432c, 432d.

Referring again to FIG. 11, the invention also provides a third fluid line 438 to define a separate feed circuit to the pumps 432, 432a to enhance the operation of the system 410. The fluid line 438 cap improve the cold temperature response of the system especially during braking operations in which the driver of the vehicle is not engaging the brake pedal and the pumps 432, 432a act as suction pump. The fluid line 38 can communicate fluid from the reservoir 414 to the line portion 464 at the first position 440 along -the second fluid line 426. The fluid line 438 can be larger than the other fluid lines 416, 426 of the system to reduce the restriction acting against fluid movement between the reservoir 414 and the pumps 432, 432a. By way of example and not limitation, the fluid line 438 can be a 10 millimeter hose and the other fluid line portions 460, 462, 464, 466 can be 6 millimeter brake lines.

A first prime valve 442 is disposed along the third fluid line 438 between the reservoir 414 and the first position 440. In the exemplary embodiment of the invention, the valve 442 is a solenoid check valve set in a first position when de-energized to prevent fluid from moving to the reservoir 414. The valve 442 can be selectively moved to a second position when energized to reduce the restriction acting against fluid movement from the reservoir 414 to the pumps 432, 432a. A second prime valve 444 is disposed along the second fluid line 426 between the line portions 460, 462. In the exemplary embodiment of the invention, the prime valve 444 is a solenoid check valve set in a first position when de-energized to prevent the high pressure of the master cylinder primary circuit from entering inlets to pumps 432, 432a in base brake operation. The valve 444 moves to the open position when energized to reduce the restriction acting against fluid movement from the line 416 to the pumps 432, 432a. The first and second prime valves 442, 444 are energized during a controlled braking event to provide parallel flow paths to the inlets of pumps 432, 432a. The first prime valve 442 can be larger than the second prime valve 444 for the same electrical energy consumption since it is only exposed to reservoir inlet pressures.

A controller 456 can control the motor 433 to control the operation of the pumps 432, 432a. The controller 456 can also control the movement of the valves 442, 444. The controller 456 can control the motor 433 and valves 442, 444, in accordance with a program stored in memory to enhance the deceleration of the vehicle.

The present invention can also be used in a braking system having a Front/Front/Rear/Rear configuration. An embodiment of the invention used in combination with a Front/Front/Rear/Rear system would include a plurality of pumps disposed in each of the separate hydraulic circuits. The present invention can be used with any braking system having a pre-charge.

Having described the invention in detail and by reference to the preferred embodiments, it will be apparent that modifications and variations thereof are possible without departing from the scope of the invention.

1. A braking system comprising:
a master cylinder;
a brake subsystem for applying pressure to a brake rotor;
an apply conduit configured to selectively to allow the flow of fluid therethrough from said master cylinder to said brake subsystem to thereby cause said brake subsystem to apply or increase pressure to said brake rotor; and
a bypass conduit configured to selectively allow the flow of fluid therethrough from said master cylinder to said brake subsystem to thereby cause said brake subsystem to apply pressure to said brake rotor.

2. The braking system of claim 1 wherein said bypass conduit and said apply conduit are arranged in parallel.

3. The braking system of claim 1 wherein said apply conduit includes an apply valve located therein to selectively control the flow of fluid therethrough, and said bypass conduit includes a bypass valve located therein to selectively control the flow of fluid therethrough.

4. The braking system of claim 3 wherein said bypass conduit includes a check valve located in said bypass conduit and between said bypass valve and said brake subsystem and configured to generally allow fluid to flow from said bypass valve to said brake subsystem and to generally block fluid from flowing from said brake subsystem to said bypass valve.

5. The braking system of claim 3 wherein said bypass valve is sized to provide a greater fluid flow rate therethrough, when open, than through said apply valve when open.

6. The braking system of claim 5 wherein when open said bypass valve had an orifice surface area that is at least about 1.5 times greater than an orifice surface area of said apply valve when open.

7. The braking system of claim 1 further comprising a release conduit configured to selectively to allow the flow of fluid therethrough and away from said brake subsystem to thereby cause said brake subsystem to reduce any pressure to said brake rotor.

8. The braking system of claim 7 further comprising a pump having a pump inlet and a pump outlet, and wherein said release conduit is in fluid communication with said pump inlet to allow fluid to flow from said brake subsystem to said pump inlet.

9. The braking system of claim 8 wherein said pump outlet is in fluid communication with said apply conduit.

10. The braking system of claim 7 wherein said apply conduit includes an apply valve located therein to selectively control the flow of fluid therethrough, and said bypass conduit includes a bypass valve located therein to selectively control the flow of fluid therethrough, and said release conduit includes a release valve located therein to selectively control the flow of fluid therethrough.

11. The braking system of claim 10 wherein each of said apply, release, and bypass valves are two-position valves that are movable between an open position which allows the flow of fluid therethrough and a closed position which generally blocks the flow of fluid therethrough.

12. The braking system of claim 11 wherein said bypass valve is biased into its open position.

13. The braking system of claim 11 wherein said apply valve is biased into its open position and said release valve is biased into its closed position.

14. The braking system of claim 11 wherein said system is configured such that said bypass valve is moved into its closed position during a controlled braking event.

15. The braking system of claim 14 wherein a controlled braking event includes anti-lock braking operation, or traction control operations, or electronic stability control operations.

16. The braking system of claim 7 further comprising:
an auxiliary brake subsystem for applying pressure to an auxiliary brake rotor;
an auxiliary apply conduit configured to selectively to allow the flow of fluid therethrough from said master cylinder to said auxiliary brake subsystem to thereby cause said auxiliary brake subsystem to apply or increase pressure to said auxiliary brake rotor; and
an auxiliary release conduit configured to selectively to allow the flow of fluid therethrough and away from said auxiliary brake subsystem to thereby cause said auxiliary brake subsystem to reduce any pressure to said auxiliary brake rotor.

17. The braking system of claim 16 wherein said bypass conduit is configured to selectively allow the flow of fluid therethrough from said master cylinder to said auxiliary brake subsystem to thereby cause said auxiliary brake subsystem to apply or increase pressure to said auxiliary brake rotor.

18. The braking system of claim 17 wherein said bypass conduit includes a bypass valve located therein to selectively control the flow of fluid therethrough such that said bypass valve controls the flow of fluid to said brake subsystem and to said auxiliary brake subsystem.

19. The braking system of claim 18 wherein said brake subsystem and said auxiliary brake subsystem are part of the same brake circuit.

20. The braking system of claim 16 further comprising an auxiliary bypass conduit that is configured to selectively allow the flow of fluid therethrough from said master cylinder to said auxiliary brake subsystem to thereby cause said auxiliary brake subsystem to apply or increase pressure to said auxiliary brake rotor.

21. The braking system of claim 20 wherein said bypass conduit includes a bypass valve located therein to selectively control the flow of fluid therethrough and wherein said auxiliary bypass conduit includes an auxiliary bypass valve located therein to selectively control the flow of fluid therethrough.

22. The braking system of claim 21 wherein said brake subsystem and said auxiliary brake subsystem are part of differing brake circuits.

23. The braking system of claim 16 further comprising further comprising a pump having a pump inlet and a pump outlet and a prime conduit in fluid communication with said master cylinder and said pump inlet, and wherein said pump outlet is in fluid communication with said apply conduit, and wherein said braking system further includes an isolation valve located in said apply conduit to control the flow of fluid therethrough and a prime valve located in said prime conduit to control the flow of fluid therethrough.

24. The braking system of claim 23 further comprising an auxiliary prime conduit in fluid communication with said master cylinder and said pump inlet, and wherein said pump outlet is in fluid communication with said auxiliary apply conduit, and wherein said braking system further includes a three way valve movable between a first position wherein said master cylinder and said auxiliary apply line are in fluid communication via said three way valve and a second position wherein said master cylinder and said auxiliary prime conduit are in fluid communication via said three way valve.

25. The braking system of claim 24 wherein when said three way valve is in said first position said master cylinder and said auxiliary prime valve are not in fluid communication via said three way valve and wherein when said three way valve is in said second position said master cylinder and said auxiliary apply conduit are not in fluid communication via said three way valve.

26. The braking system of claim 1 wherein said brake subsystem includes a brake pad for applying pressure to said brake rotor and wherein the system further includes a vehicle wheel rotationally coupled to said brake rotor.

27. A braking system comprising:
a master cylinder having a reservoir;
a brake subsystem for applying pressure to a brake rotor;
an apply conduit configured to selectively to allow the flow of fluid therethrough from said master cylinder to said brake subsystem to thereby cause said brake subsystem to apply or increase pressure to said brake rotor;
a release conduit configured to selectively to allow the flow of fluid therethrough and away from said brake subsystem to thereby cause said brake subsystem to reduce any pressure to said brake rotor;
a pump having a pump inlet and a pump outlet, and wherein said release conduit is in fluid communication with said pump inlet; and
a reservoir conduit configured to selectively allow the flow of fluid therethrough from said master cylinder to said pump inlet.

28. The braking system of claim 27 wherein said reservoir conduit includes a reservoir valve located therein to selectively control the flow of fluid therethrough.

29. The braking system of claim 28 wherein said apply conduit includes an apply valve located therein to selectively control the flow of fluid therethrough and said release conduit includes a release valve located therein to selectively control the flow of fluid therethrough.

30. The braking system of claim 28 further comprising a prime conduit in fluid communication with said master cylinder and said pump inlet, and wherein said pump outlet is in fluid communication with said apply conduit, and wherein said braking system further includes an isolation valve located in said apply conduit and a prime valve located in said prime conduit to control the flow of fluid therethrough.

31. A braking system for a vehicle comprising:
a master cylinder;
a fluid line assembly in fluid communication with master cylinder and at least one brake disposed at a wheel of said vehicle; and
a pumping unit in fluid communication with said fluid line assembly, said pumping unit including two fluid pumping elements that are arranged to be about 180 degrees out of phase with each other during operation.

32. The braking system of claim 31 wherein each pumping element is a piston received in a cylinder.

33. The braking system of claim 32 further comprising a rotational eccentric coupled to both of said pistons such that rotation of said eccentric causes reciprocal motion of both said pistons.

34. The braking system of claim 31 further comprising a supplemental pumping unit in fluid communication with said fluid line assembly, said supplemental pumping unit including two fluid pumping elements.

35. The braking system of claim 34 wherein said two fluid pumping elements of said supplemental pumping unit are arranged to be about 180 degrees out of phase with each other during operation.

36. The braking system of claim 35 wherein said supplemental pumping unit is arranged to be out of phase with said pumping unit during operation

37. The braking system of claim 36 wherein said supplemental pumping unit is arranged to be about 90 degrees out of phase with said pumping unit during operation.

38. The braking system of claim 36 wherein said supplemental pumping unit is arranged to be about 180 degrees out of phase with said pumping unit during operation.

39. The braking system of claim 34 wherein said supplemental pumping unit is arranged to be substantially in phase with said pumping unit during operation.

40. The braking system of claim 34 wherein said fluid line assembly includes a primary line portion which controls braking of two wheels of a vehicle, and a secondary line portion which controls braking of another two wheels of a vehicle, and wherein two of said pumping elements are fluidly coupled to said primary line portion and the other two of said pumping elements are fluidly coupled to said secondary line portion.

41. The braking system of claim 34 wherein said fluid line assembly includes a primary line portion which controls braking of two wheels of a vehicle, and a secondary line portion which controls braking of another two wheels of a vehicle, and wherein three of said pumping elements are fluidly coupled to said primary line portion and the remaining pumping element is fluidly coupled to said secondary line portion.
